(19) United States
(12) Patent Application Publication
(10) Pub. No.: US 2007/0012887 A1
(43) Pub. Date: Jan. 18, 2007

(54) Solid-state light source

(76) Inventors: Martin Letz, Mainz (DE); Karine Seneschal-Merz, Mainz (DE); Ulrich Peuchert, Bodenheim (DE); Axel Engel, Ingelheim (DE); Edgar Pawlowski, Stadecken-Elsheim (DE); Thilo Zachau, Buerstadt-Riedrode (DE); Joseph S. Hayden, Clarks Summit, PA (US); Carol Click, Clarks Green, PA (US)

Correspondence Address: HARNESS, DICKEY & PIERCE, P.L.C., P.O. BOX 828, BLOOMFIELD HILLS, MI, 48303, US

(21) Appl. No.: 11/473,409

(22) Filed: Jun. 22, 2006

(30) Foreign Application Priority Data
Jun. 30, 2005 (DE) 10 2005 031 523.2

(51) Int. Cl. G01J 1/58

(52) U.S. Cl. 250/486.1

(57) ABSTRACT

The invention describes a solid-state light source comprising a solid-state emitter designed for emitting light energy, which preferably has an LED, a luminescent light conversion medium, made from glass or glass ceramics, for converting emitted light energy to light energy of a different frequency spectrum, and a coupling medium for decoupling the light energy to an ambient medium, such as air, the light conversion medium having a refractive index n_{cs}, selected as a function of the refractive index n_{HL} of the solid-state emitter in the range of 0.7·(n_{HL}²)^{1/3} to 1.3·(n_{HL}²)^{1/3}.

### BACKGROUND OF THE INVENTION

The present invention relates to a solid-state light source comprising a solid-state emitter designed for emitting light energy, preferably having an LED, a luminescent light conversion medium, made from glass or glass ceramics, for converting emitted light energy to light energy of a different frequency spectrum, and having a coupling medium for decoupling the light energy to an ambient medium, such as air.

In order to improve the efficiency of light sources in lighting engineering one has tried to replace conventional incandescent light sources or fluorescent light sources by solid-state light sources. Solid-state light sources in the form of LEDs produce light in a very narrow spectral band, while white light is required for illumination purposes. Commercially available white LEDs use a III nitride emitter for stimulating a luminescent material (down conversion) that emits a secondary wavelength in a lower wavelength band. One known solution uses a blue InGaN/GaN LED for stimulating YAG:CE, a broadband yellow luminescent material. With these LEDs, which have been converted using a luminescent material, a given proportion of the emitted blue light passes the luminescent layer covering the LED chip so that the overall spectrum obtained assumes a color very close to white light. Due to the absence of any spectral portions in the blue/green band and in the red wavelength band, the resulting color is not satisfactory in most of the cases.

Another solution consists in the use of a solid-state emitter, emitting in the UV or the near UV range, which is coupled to a full-color luminescent system. It is thereby possible to realize white light sources that are satisfactory in terms of color (compare Phys. Stud. Sol. (a) 192 No. 2, 237-245 (2002, M. R. Krames et al.: High-Power III-Nitride Emitters for Solid-State Lighting”).

The luminescent particles are embedded in this case in epoxy resin and are applied onto the solid-state emitter as a luminescent layer.

Embedding the luminescent materials used in epoxy resin leads, however, to certain disadvantages with the before-mentioned luminescent systems that serve for converting the light emitted by the LEDs to a desired spectral range, especially for producing white light. The granulates used lead to scattering losses. A non-homogeneous distribution of the granulate on the solid-state emitter may lead to variable color perception as a function of angle. In addition, epoxy resins are instable over time in many respects, especially with respect to their optical and mechanical properties. And as a rule, thermal stability and stability to short-wave radiation in the blue or the UV spectral band is also unsatisfactory. Moreover, production of such conversion layers is complex and expensive.

US 2003/0025449 A1 discloses an LED according to the preamble of Claim 1, where the light emitted by an LED chip passes a cavity which is filled with a UV-stable optical medium having a refractive index of 1.4 to 1.5, and then reaches a cap, which consists of luminescent glass, for converting the emitted light to a longer-wave spectral band. In an alternative embodiment, the cavity surrounding the chip is filled with an optical coupling medium in the form of a luminescent material designed in such a way that the entire emission spectrum appears to be white. The cap 18 in this case has optical properties and may be an optic Fresnel lens, a bifocal lens, a plano-convex or a plano-concave lens, for example.

Another solid-state light source according to the preamble of Claim 1 has been known from DE 103 11 820 A1.

The light emitted by the LED is converted in this case to longer-wave light via a luminescent glass body consisting of a base glass with a rare earth doping. The rare earth doping may take a proportion of up to 30 % by weight. It preferably consists of Eu₂O₃ or CeO₂. The base glass may be a borosilicate glass, an alkaline earth borosilicate glass, an alumino-borosilicate glass, a lead-silicate glass (optical flint), a soda-lime glass (crown glass), an alkali-alkaline earth silicate glass, a lanthanide borate glass or a barium oxide silicate glass. Especially preferred as a base glass is a fluoro-phosphate glass.

Although a significant improvement has been achieved according to the two last-mentioned documents, in that the use of glass or glass ceramics as a luminescent conversion material leads to improved homogeneity and long-term stability, the known systems still have disadvantages. In particular, reflection losses at the interfaces between the different components of the system are relatively high.

### SUMMARY OF THE INVENTION

It is a first object of the present invention to provide an improved solid-state light source in which reflection losses are kept as low as possible.

It is a second object of the present invention to provide an improved solid-state light source which exhibits a simple structure with long-term stability.

It is a third object of the present invention to provide an improved solid-state light source having a good conversion efficiency for downconverting light emitted from a solid-state light source within the blue or UV range, preferably to generate white light.

These and other objects of the invention are achieved with a solid-state light source of the type described at the outset by selecting the light conversion medium so as to have a refractive index n_{cs} determined as a function of the refractive index n_{HL} of the solid-state emitter, in the range of 0.7·(n_{HL}²)^{1/3} to 1.3·(n_{HL}²)^{1/3}, preferably in the range of 0.8·(n_{HL}²)^{1/3} to 1.2·(n_{HL}²)^{1/3}, most preferably in the range of 0.9·(n_{HL}²)^{1/3} to 1.1·(n_{HL}² )^{1/3}.

The object of the invention is thus perfectly achieved.

With a refractive index of the conversion medium selected in this way refraction losses are minimized at the transition of the light energy from the solid-state emitter to the light conversion medium. The efficiency of the solid-state light source is, thus, clearly increased.

According to a preferred further development of the invention, the coupling medium is a glass, a glass ceramics material or a plastic material.

The coupling medium may in this case be configured as a lens so as to achieve bundled light emission from the solid-state light source.

According to a preferred further development of the invention, the coupling medium has a refractive index nₒₒ, selected as a function of the refractive index n_{HL} of the solid-state emitter, in the range of 0.7·(n_{HL})^{1/3} to 1.3·(n_{HL})^{1/3}, preferably in the range of 0.8·(n_{HL})^{1/3} to 1.2·(n_{HL})^{1/3}, most preferably in the range of 0.9·(n_{HL})^{1/3} to 1.1·(n_{HL})^{1/3}.

In this way, both the refractive index of the light conversion medium and the refractive index of the coupling medium are aligned to the refractive index of the solid-state emitter. This permits especially high luminous efficiency to be achieved because reflection losses are avoided.

In principle, it is imaginable for the light conversion medium and the coupling medium to be identical. As a rule, however, a separate coupling medium is used in order to achieve suitable light control.

According to a preferred further development of the invention, the light conversion medium is designed for conversion of light energy in the blue band or in the UV band to white light.

This provides the advantage that LEDs emitting in the blue and in the UV band (for example in the band of 350 to 480 nm) may be used to produce white light.

According to a further embodiment of the invention, the light conversion medium has a coefficient of thermal expansion adapted to the coefficient of thermal expansion of the substrate of the solid-state emitter.

The coefficient of thermal expansion of the light conversion medium is at least equal to 2.5·10⁻⁶/K. Preferably, that coefficient is adapted to the coefficient of thermal expansion of the material making up the solid-state emitter, which is (in 10⁻⁶/K):

| | |
|---|---|
| InN | 3.8/2.9 |
| GaN | 3.17/5.59 |
| GaP | 4.65 |
| AlN | 5.27/4.15 |
| Al₂O₃ | 5.6/5.0 |

Where two values are stated above, these relate to the coefficient of thermal expansion for anisotropic materials.

Stresses that may occur due to temperature differences between the solid-state emitter or the substrate on which the latter is applied and the light conversion medium are thus avoided.

According to another embodiment of the invention, the light conversion medium comprises an optically transparent base material doped with at least one rare-earth metal, especially with Ce, Eu, Tb, Tm or Sm, of a fluorescent or luminescent kind.

According to a further embodiment of the invention, the base material used is a lanthanum phosphate glass, a fluoro-phosphate glass, a fluor crown glass, a lanthanum glass, a glass ceramics material produced therefrom, a lithium-aluminosilicate glass ceramics material or a glass ceramics material containing high quantities of yttrium.

According to a preferred further development of the invention, the base material is additionally doped with a material that supports stronger absorption at the stimulation wavelength. Especially preferred as such dopant is bismuth or another non-ferrous metal such as Mn, Ni, CO or chromium.

Given the fact that rare earths have a small absorption band, clearly wider absorption in the UV band can be achieved in this way if doping is effected using a d-orbital metal.

The proportion of the additional doping with bismuth or non-ferrous metals may amount to approximately 3 to 100 ppm in this case.

According to a further embodiment of the invention, the base material is a lanthanum phosphate glass containing 30 to 90% by weight P₂O₅, preferably 50 to 80% by weight, most preferably 60 to 75% by weight P₂0₅, as well refining agents in usual quantities.

According to a further embodiment of the invention, the base material used is a lanthanum phosphate glass containing 1 to 30% by weight La₂O₃, preferably 5 to 20% by weight, most preferably 8 to 17% by weight La₂O₃.

According to a further embodiment of the invention, the base material may further contain 1 to 20% by weight Al₂O₃, for example 5 to 15% by weight Al₂O₃.

According to a further embodiment of the invention, the base material contains 1 to 20% by weight R₂O, where R is at least one element selected from the group of alkaline metals.

According to a further development of that embodiment, the base material contains 1 to 20% by weight K₂O, preferably 5 to 15% by weight K₂O.

According to a further embodiment of the invention, the base material may be a fluorophosphate glass containing 5 to 40% by weight P₂O₅ and a proportion of fluoride of 60 to 95% by weight.

According to a further embodiment of the invention, the base material is an optical glass containing 0.5 to 2% by weight La₂O₃, 10 to 20% by weight B₂O₃, 5 to 25% by weight SiO₂, 10 to 30% by weight SrO, 2 to 10% by weight CaO, 10 to 20% by weight BaO, 0.5 to 3% by weight Li₂O, 1 to 5% by weight MgO and 20 to 50% by weight F as well as refining agents in usual quantities.

According to a further development of the invention, the base material is an optical glass containing 30 to 60% by weight La₂O₃, 30 to 50% by weight B₂0₃, 1 to 5% by weight SiO₂, 1 to 15% by weight ZnO, 2 to 10% by weight CaO as well as refining agents in usual quantities.

Such compositions of the light conversion medium permit highly stable light conversion media to be obtained with their refractive indices, depending on the selected composition, lying in the desired range as a function of the refractive index of the solid-state emitter.

According to a further embodiment of the invention, the outer surface of the coupling medium is provided with a structure, the elements of such structure having a size of between 50 nm and 2000 nm.

Preferably, diffractive optical elements are provided for this purpose on the outer surface of the coupling medium.

This has the effect to minimize reflection losses at the transition from the coupling medium to the surrounding medium.

According to a further embodiment of the invention, the solid-state light source comprises a base material of glass or glass ceramics containing at least the components SiO₂, Al₂O₃ and Y₂O₃, the ratio by weight between Y₂O₃ and the total weight of SiO₂, Al₂O₃ and Y₂O₃ being at least 0.2, preferably at least 0.3, most preferably at least 0.4.

Preferably, the maximum weight ratio between SiO₂ and the total weight of SiO₂, Al₂O₃ and Y₂O₃ does not exceed 0.5 in this case.

Preferably, the maximum weight ratio between Al₂O₃ and the total weight of SiO₂, Al₂O₃ and Y₂O₃ does not exceed 0.6, more preferably 0.55 in this case.

Such compositions, when subjected to a suitable thermal treatment, allow the separation of crystal phases that may serve as host phases for rare earths.

Suited as composition for the base material are in this case (in % by weight on an oxide basis):

| | |
|---|---|
| SiO₂ | 10-40 |
| Al₂O₃ | 10-40 |
| Y₂O₃ | 20-70 |
| B₂O₃ | 0-15 |
| rare earths | 0.5-15. |

It is understood that the features of the invention mentioned above and those yet to be explained below can be used not only in the respective combination indicated, but also in other combinations or in isolation, without leaving the scope of the invention.

### BRIEF DESCRIPTION OF THE FIGURES

Further features and advantages of the invention will become apparent from the description that follows of a preferred embodiment of the invention, with reference to the drawing. In the drawings:

FIG. 1 shows a diagrammatic representation of a solid-state light source according to the invention.

### DESCRIPTION OF PREFERRED EMBODIMENTS

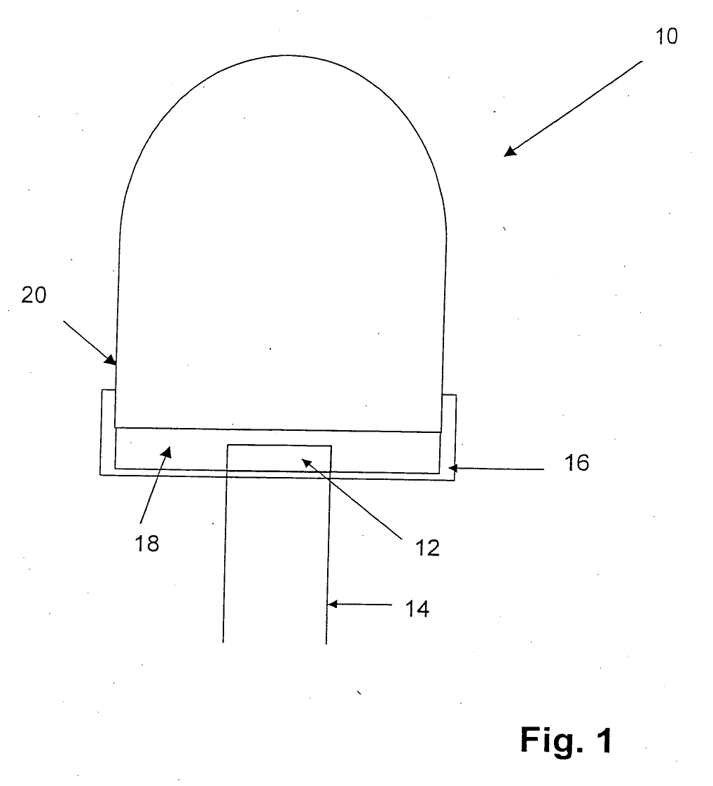

FIG. 1 shows a diagrammatic representation of a solid-state light source according to the invention, indicated generally by reference numeral 10. The solid-state light source 10 comprises a solid-state emitter (chip) 12, supported on the base of a housing 16. The solid-state emitter 12 is enclosed in a light conversion medium 18, which may be a luminescent glass or a luminescent glass ceramics material. The light conversion medium 18 is provided for this purpose with a recess conforming with the shape of the solid-state emitter 12 so that the light conversion medium can be positioned on the solid-state emitter 12. Alternatively, the solid-state emitter 12 may be directly enclosed by the housing on both sides in which case the light conversion medium is placed on the surface of the solid-state emitter only in the form of a thin plate. In any case, the inside of the housing 16 preferably is reflective in order to improve the emission of light. Above the light conversion medium 18 there is provided a coupling medium 20, which is designed as a light guide and the upper surface of which may be formed as a convex lens, for example.

According to the invention, the refractive indices of the light conversion medium 18 and the coupling medium 20 are now adapted to the refractive index of the solid-state emitter 12. To this end, the light conversion medium 18 is given a refractive index n_{cs} selected as a function of the refractive index n_{HL} of the solid-state emitter, preferably on the basis of the following formula:
n_{cs}=³\sqrt{n²_{HL}}.

Further, the coupling medium preferably has a refractive index n₀₀ selected on the basis of the following formula:
³\sqrt{n_{HL}}.

It has been found that by adapting the refractive indices for the light conversion medium and the coupling medium in this way, as a function of the refractive index of the substrate of the solid-state emitter, it is possible to minimize refraction losses.

Examples of refractive indices for solid-state materials (at 632 nm) are:
n=3.35 for GaP
n=2.20 (o) and 2.29 (e) for GaN
n=2.13 (o) and 2.20 (e) for AlN
n=2.09 for InN,
   where (o) is the ordinary and (e) is the extraordinary ray for non-cubic, double-refractive crystal phases. At shorter wavelengths (for example 460 nm or 410 nm), as used for solid-state light-emitting diodes, the refractive index is even higher.

An example of a substrate material on which the solid-state materials of the solid-state emitters have been deposited, is corundum (Al₂O₃) which has a refractive index of 1.76.

In case GaN, for example, is used as a solid-state emitter, the reflection losses can be minimized by a light conversion medium having a refractive index of between approximately 1.6 and 1.9. At the same time, the refractive index of the coupling medium is selected to be between approximately 1.15 and 1.4 in this case.

If, in contrast, the solid-state emitter consists of GaP, for example, the light conversion medium used preferably should have a refractive index approximately in a range of between 1.85 and 2.2, while the refractive index used for the coupling medium should be selected to be between approximately 1.35 and 1.5.

If, however, InP is used as a solid-state emitter, then the light conversion medium should be selected to have a refractive index greater than approximately 2.1 and smaller than approximately 2.4. The material selected for the coupling medium should in this case have a refractive index of between approximately 1.4 and 1.6.

The light conversion medium 18 is a material made from glass or glass ceramics, bulk doped with a rare earth metal, especially Ce, Eu, Tb, Tm or Sm, that is fluorescent or luminescent. That material is particularly well suited for converting light emitted by blue LEDs or LEDs emitting in the UV range to white light.

Further, the coefficient of thermal expansion of the light conversion medium is preferably adapted to the coefficient of thermal expansion of the solid-state emitter in this case, which preferably is at least 2.5·10⁻⁶/K. Further, the coefficient of thermal expansion of the coupling medium may be similarly adapted to the coefficient of thermal expansion of the light conversion medium connected with it, and may preferably be at least 2.5·10⁻⁶/K.

In addition to the rare earth doping a supplementary dopant, for example Mn, Ni, Co, Cr and/or Bi, is preferably used in order to achieve higher absorption at the stimulation wavelength.

In order to render production especially easy, the coupling medium 20 may also consist of a polymer as a polymer permits the desired adaptation of the refractive index to the refractive index of the solid-state emitter to be achieved without difficulty. This then allows an especially simple and low cost production process to be realized.

Even though the coupling medium is made from glass or glass ceramics, the material used preferably is selected to melt at low temperatures in order to permit the coupling medium to be directly pressed to the desired shape.

Preferably, the outer surface of the coupling medium 20 is additionally provided with diffractive optical elements, for example in the form of microlenses, having a diameter of between 50 nm and 2000 nm, in order to support effective coupling-out of the light.

### EXAMPLE 1

Compositions of different lanthanum phosphate glass types that are single-doped with Cr₂O₃ or multiple-doped with rare earth ions, are summarized in Table 1:

TABLE 1

| OXIDE | wt.-% | wt.-% | wt.-% | wt.-% | wt.-% |
|---|---|---|---|---|---|
| Sample | A | B | C | D | E |
| Al₂O₃ | 8.498 | 8.774 | 8.857 | 8.498 | 8.498 |
| P₂O₅ | 68.378 | 70.593 | 71.267 | 68.378 | 68.378 |
| K₂O | 9.316 | 6.328 | 6.388 | 9.316 | 9.316 |
| La₂O₃ | 13.808 | 14.256 | 10.669 | 13.808 | 13.808 |
| Ce₂O₃ | | | 0.126 | 0.13 | 1.21 |
| Eu₂O₃ | | | | 1.24 | 1.23 |
| Tb₂O₃ | | | 2.693 | 2.63 | 2.62 |
| Cr₂O₃ | | 0.050 | | | |
| Tm₂O₃ | | | | | 1.02 |

### EXAMPLE 2

The fluorophosphate glass types used have a P₂O₅ content of 5 to 40% by weight and a fluoride content of 60 to 96% by weight. The glass is doped with rare earths to between approximately 0.5 and 15% by weight.

### EXAMPLE 3

A lithium aluminum glass ceramics material (LAS ceramics) is doped with rare earths. The material used may especially consist of an LAS glass ceramics material marketed by Schott under the trade marks Ceran®, CLEARTRANS® or ROBAX®.

### EXAMPLE 4

A glass with a high lanthanum content is molten which has a refractive index of over 1.7. The glass has the following composition (in % by weight on an oxide basis):

| | |
|---|---|
| SiO₂ | 4.3 |
| B₂O₃ | 34.3 |
| Al₂O₃ | 0.4 |
| ZrO₂ | 5.4 |
| La₂O₃ | 41.0 |
| CaO | 1.6 |
| ZnO | 6.0 |
| CdO | 6.4 |
| Li₂O | 0.3 |
| As₂O₃ | 0.3. |

The lanthanum oxide may be replaced in this case in part by oxides of the rare earths.

### EXAMPLE 5

A glass containing the following components (in % by weight on an oxide basis) is molten:

| | |
|---|---|
| SiO₂ | 23.64 |
| B₂O₃ | 6.36 |
| Al₂O₃ | 20.91 |
| Y₂O₃ | 46.36 |
| Eu₂O₃ | 2.73. |

The glass obtained is molten and homogenized in a platinum crucible at a temperature of approximately 1550 to 1600° C. After the material has cooled down to room temperature, a clear transparent glass is obtained.

When stimulated with UV light (λ=240 to 400 nm) the glass shines in a bright orange color both in its glassy and in its ceramized condition.

The glass can be ceramized by a suitable temperature treatment during which process crystal phases can be separated that serve as host phases for rare earth ions.

The material is also especially well suited as light conversion medium.

Therefore, what is claimed, is:

1. A solid-state light source comprising:
a solid-state emitter designed for emitting light energy;
a luminescent light conversion medium for converting emitted light energy to light energy of a different frequency spectrum, said luminescent light conversion medium being made from a material selected from the group formed by a glass and a glass ceramic; and
a coupling medium for decoupling light energy emerging from said luminescent light conversion medium to an ambient medium;
said light conversion medium having a refractive index n_{cs}, selected as a function of the refractive index n_{HL} of the solid-state emitter in the range of: 0.7·(n_{HL}²)^{1/3}≦n_{cs}≦1.3·(n_{HL}²)^{1/3}; and
said coupling medium having a refractive index nₒₒ being selected as a function of the refractive index n_{HL} of said solid-state emitter in the range of: 0.7·(n_{HL})^{1/3}≦nₒₒ≦1.3·(n_{HL})^{1/3}.

2. The solid-state light source of claim 1, wherein said light conversion medium has a refractive index n_{cs} selected in the range of: 0.8·(n_{HL}²)^{1/3}≦n_{cs}≦1.2·(n_{HL}²)^{1/3}.

3. The solid-state light source of claim 1, wherein said light conversion medium has a refractive index n_{cs} selected in the range of: 0.9·(n_{HL}²)^{1/3}≦n_{cs}≦1.1·(n_{HL}²)^{1/3}.

4. The solid-state light source of claim 1, wherein said solid-state emitter is configured as an LED.

5. The solid-state light source of claim 1, wherein said coupling medium is a material selected from the group formed by a glass, a glass ceramic and a plastic material.

6. A solid-state light source comprising:
a solid-state emitter designed for emitting light energy;
a luminescent light conversion medium for converting emitted light energy to light energy of a different frequency spectrum, said luminescent light conversion medium being made from a material selected from the group formed by a glass and a glass ceramic; and
a coupling medium for decoupling light energy emerging from said luminescent light conversion medium to an ambient medium;
said light conversion medium having a refractive index n_{cs}, selected as a function of the refractive index n_{HL} of the solid-state emitter in the range of: 0.7·(n_{HL}²)^{1/3}≦n_{cs}≦1.3·(n_{HL}²)^{1/3}.

7. The solid-state light source of claim 6, wherein said coupling medium has a refractive index nₒₒ being selected as a function of the refractive index n_{HL} of said solid-state emitter in the range of: 0.7·(n_{HL})^{1/3}≦nₒₒ≦1.3·(n_{HL})^{1/3}.

8. The solid-state light source of claim 1, wherein said coupling medium has a refractive index in the range of: 0.8·(n_{HL})^{1/3}≦nₒₒ≦1.2·(n_{HL})^{1/3}.

9. The solid-state light source of claim 6, wherein said coupling medium has a refractive index in the range of: 0.9·(n_{H}L)^{1/3}≦nₒₒ≦1.1·(n_{HL})^{1/3}.

10. The solid-state light source of claim 6, wherein said light conversion medium comprises an optically transparent base material doped with at least one luminescent rare-earth metal configured for downconversion of light energy.

11. The solid-state light source of claim 6, wherein an outer surface of said coupling medium comprises a structured surface, comprising optical elements having a size of between 50 nm and 2000 nm.

12. The solid-state light source of claim 6, wherein said light conversion medium has a coefficient of thermal expansion (CTA) being closely adapted to a coefficient of thermal expansion of the solid-state emitter, wherein a difference between the CTA of the light conversion medium and the CTA of the solid-state emitter is within a range of ±2·10⁻⁶/K.

13. The solid-state light source of claim 6, wherein said light conversion medium has a coefficient of thermal expansion (CTA) being closely adapted to a coefficient of thermal expansion of the solid-state emitter, wherein a difference between the CTA of the light conversion medium and the CTA of the solid-state emitter is within a range of ±1·10⁻⁶/K.

14. The solid-state light source of claim 1, wherein said light conversion medium has a coefficient of thermal expansion (CTA) being closely adapted to a coefficient of thermal expansion of the solid-state emitter, wherein a difference between the CTA of the light conversion medium and the CTA of the solid-state emitter is within a range of ±0.5·10⁻⁶/K.

15. The solid-state light source of claim 6, wherein said light conversion medium has a coefficient of thermal expansion (CTA) of at least 2.5·10⁻⁶/K.

16. The solid-state light source of claim 1, wherein said light conversion medium has a coefficient of thermal expansion (CTA) of at least 2.9·10⁻⁶/K.

17. The solid-state light source of claim 15, wherein said light conversion medium has a coefficient of thermal expansion (CTA) of 6·10⁻⁶/K at the most.

18. The solid-state light source of claim 6, wherein said coupling medium has a coefficient of thermal expansion which is at least 2.5·10⁻⁶/K.

19. The solid-state light source of claim 18, wherein said coupling medium has a coefficient of thermal expansion which is 6·10⁻⁶/K at the most.

20. The solid-state light source of claim 1, wherein said light conversion medium has a coefficient of thermal expansion (CTA) of at least 2.9·10⁻⁶/K;
wherein said light conversion medium has a coefficient of thermal expansion (CTA) of 6·10⁻⁶/K at the most and wherein an outer surface of said coupling medium comprises a structured surface having at least one diffractive optical element having a size of between 50 nm and 2000 nm.
